(19) United States
(12) Patent Application Publication
(10) Pub. No.: US 2021/0229640 A1
(43) Pub. Date: Jul. 29, 2021

(54) Brake Sphere for Spherical Braking Apparatus

(71) Applicant: Lewis Designs, LLC, Waterford, PA (US)

(72) Inventor: Aaron J. Lewis, Erie, PA (US)

(73) Assignee: Lewis Designs, LLC, Waterford, PA (US)

(21) Appl. No.: 16/322,716

(22) PCT Filed: Aug. 1, 2016
(86) PCT No.: PCT/US2016/044995

§ 371 Date: Feb. 1, 2019

(51) Int. Cl. B60T 1/06; F16D 49/16; F16D 65/807; F16D 65/18; B60T 13/12

(52) U.S. Cl. CPC B60T 1/067; F16D 49/16; F16D 2121/04; F16D 65/18; B60T 13/12; F16D 65/807

(57) ABSTRACT

A brake sphere apparatus of a spherical braking system is mounted on the axle or drive shaft of a vehicle. A brake sphere is connected to a wheel hub and rotates simultaneously together with the wheel hub. A housing contains the brake sphere, two brake pads on opposing sides of the brake sphere, and two hydraulic shafts respectively driving the two brake pads. Two hydraulic lines are connected to the two hydraulic shafts through the housing, the two hydraulic shafts press the two brake pads against the brake sphere when pressure is applied through the two hydraulic lines. Cooling is provided to cool the brake sphere when torque is applied to said brake sphere to decrease simultaneous rotation of the brake sphere and wheel hub.

### CROSS-REFERENCE TO RELATED APPLICATIONS

The present application claims the benefit of U.S. Provisional Application No. 61/787,817 filed on Mar. 15, 2013 and of U.S. Provisional Application No. 61/831,432 filed on Jun. 5, 2013, each of which applications is incorporated herein by reference in its entirety.

### FEDERALLY SPONSORED RESEARCH

Not Applicable.

### FIELD OF THE INVENTION

The present invention relates to vehicle braking. More particularly, the present invention relates to a brake apparatus mounted on an axle of a vehicle for a spherical braking system.

### BACKGROUND

Typical vehicle braking systems contain a storage tank for hydraulic fluid, brake cylinders, a set of fluid lines and the like. When the driver depresses the brake pedal, the fluid from the storage tank is transferred through hydraulic lines to the hydraulic brake cylinders. The brake cylinders then causes mating parts, such as brake pads to come into contact with a brake drum or a flat circular rotor attached to a vehicle's wheel, thereby slowing the vehicle's speed.

An advanced spherical braking system was disclosed in U.S. Pat. No. 8,453,811 issued on Jun. 4, 2013, which is hereby incorporated by reference in its entirety. One brake pad was mounted above the brake sphere and the other mounted below, on at least one segment of a brake housing. A hydraulic shaft encircled by a bushing was connected to the brake pad. Braking torque was generated by vertical movement of the brake pads against the brake sphere and hence the drive shaft which thereby slowed the rotation of the drive shaft.

### BRIEF SUMMARY

The preferred embodiments of the invention relate to an improved brake apparatus for a spherical braking system. The housing of the brake apparatus in the preferred embodiments has openings so as to facilitate cooling of the brake sphere during braking. The brake apparatus is integrated with an axle of the vehicle to facilitate

[symbol]

In a first aspect of the invention, a brake sphere apparatus of a spherical braking system is mounted on the axle or drive shaft of a vehicle. A brake sphere is connected to a wheel hub and rotates simultaneously together with the wheel hub. A housing supports the brake sphere, two brake pads on opposing sides of the brake sphere, and two hydraulic shafts respectively driving the two brake pads. Two hydraulic lines are connected to the two hydraulic shafts through the housing, the two hydraulic shafts press the two brake pads against the brake sphere when pressure is applied through the two hydraulic lines. Cooling is provided to cool the brake sphere when torque is applied to said brake sphere to decrease simultaneous rotation of the brake sphere and wheel hub.

### BRIEF DESCRIPTION OF THE DRAWINGS

These and other features, aspects and advantages of the present invention will become better understood with regard to the following description, appended claims, and accompanying drawings where:

FIG. 1 is a side view of one of the brake spheres on an axle according to a first preferred embodiment of the invention, with a hydraulic shaft and axle splines shown by dashed lines.

FIG. 2 is a simplified version of FIG. 1 without markings.

FIG. 3 shows the brake sphere of FIG. 1 with labels.

FIG. 4 shows two brake spheres on the same axle according to the first preferred embodiment of the invention.

FIG. 5 shows the brake sphere of FIG. 2 which rotation and translational movement marked by arrows.

FIG. 6 is a first perspective view of the brake sphere on the axle in the first preferred embodiment of the invention.

FIG. 7 is a second perspective view of the brake sphere on the axle in the first preferred embodiment of the invention.

FIG. 8 is a third perspective view of the brake sphere on the axle in the first preferred embodiment of the invention.

FIG. 9 is a fourth perspective view of the brake sphere on the axle in the first preferred embodiment of the invention.

FIG. 10 is a first close-up perspective view of the brake sphere on the axle in the first preferred embodiment of the invention.

FIG. 11 is a second close-up perspective view of the brake sphere on the axle in the first preferred embodiment of the invention.

FIG. 12 is a third close-up perspective view of the brake sphere on the axle in the first preferred embodiment of the invention.

FIG. 13 is a fourth perspective view of the brake sphere on the axle in the first preferred embodiment of the invention.

FIG. 14 is an end view of the wheel hub attached to the brake sphere in the first preferred embodiment of the invention.

FIG. 15 is a second perspective view of the axle and two brake spheres shown in FIG. 4.

FIG. 16 is a third perspective view of the axle and two brake spheres shown in FIG. 4.

FIG. 17 is a fourth perspective view of the axle and two brake spheres shown in FIG. 4.

FIG. 18 is another side view of the brake sphere according to the first preferred embodiment of the invention.

FIG. 19 is a top view of the brake sphere according to the first preferred embodiment of the invention.

FIG. 20 is an illustrative diagram showing the connection of the brake sphere to the axle in the first preferred embodiment of the invention.

FIG. 21 is a perspective view of a brake sphere apparatus according to a second preferred embodiment of the invention.

FIG. 22 is an end view of a brake sphere, from the wheel hub end, according to a second preferred embodiment of the invention.

FIG. 23 is a top view of the brake sphere in FIG. 22.

FIG. 24 is a left side view of the brake sphere in FIG. 22.

FIG. 25 is a right side view of the brake sphere in FIG. 22.

FIG. 26 is a cross section view of the brake sphere along the line 1-1 in FIG. 25.

FIG. 27 is an end view, from the axle end, of the brake sphere in FIG. 22.

FIG. 28 is a cross-section view of the brake sphere along the line 2-2 in FIG. 27.

FIG. 29 is an exploded view showing the assembly of the brake sphere shown in FIG. 22.

### DETAILED DESCRIPTION OF THE PREFERRED EMBODIMENTS

Preferred embodiments of the brake apparatus for spherical braking systems will now be described with reference to the accompanying drawings. Not all aspects of the spherical braking system are explicitly described herein, such aspects such as the use of hydraulic pressure for example being previously known and need not be repeated here. Reference can be made to the spherical braking system embodiments described in U.S. Pat. No. 8,453,811 issued on Jun. 4, 2013, incorporated by reference herein, either as specifically prompted herein or as may be apparent from the description.

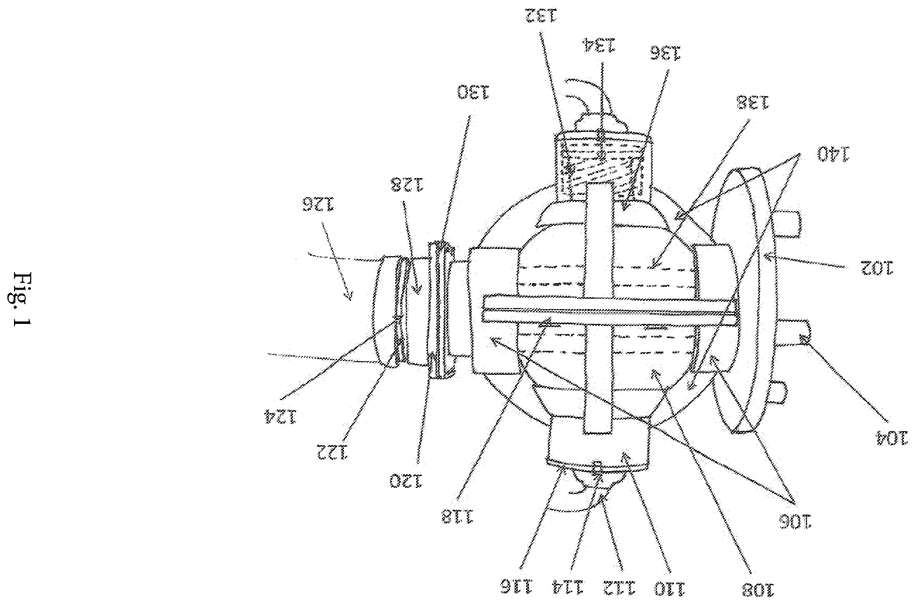

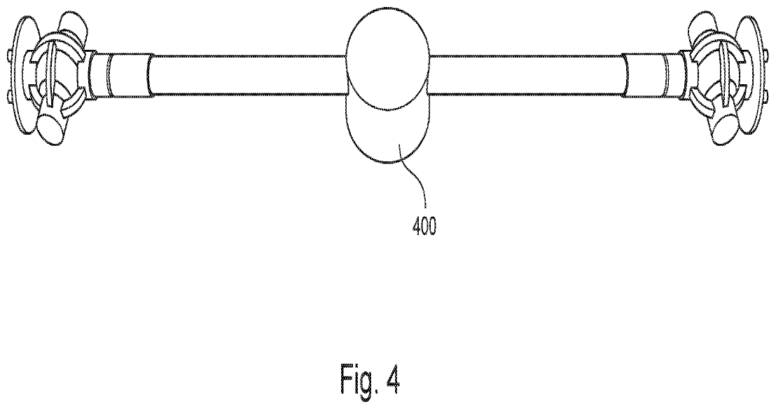

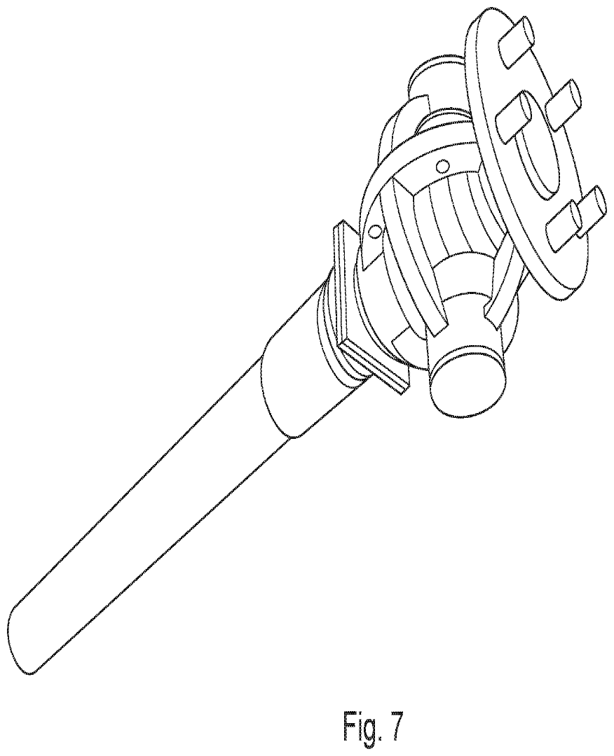

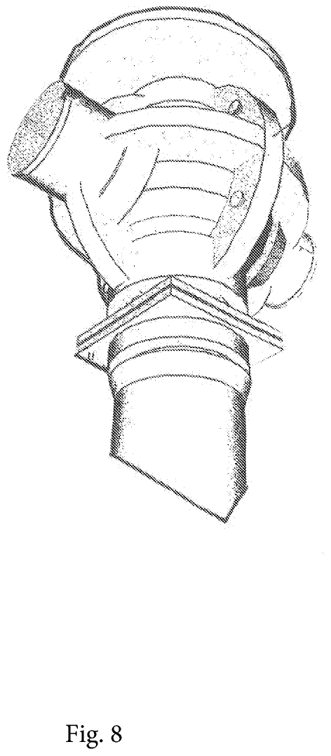

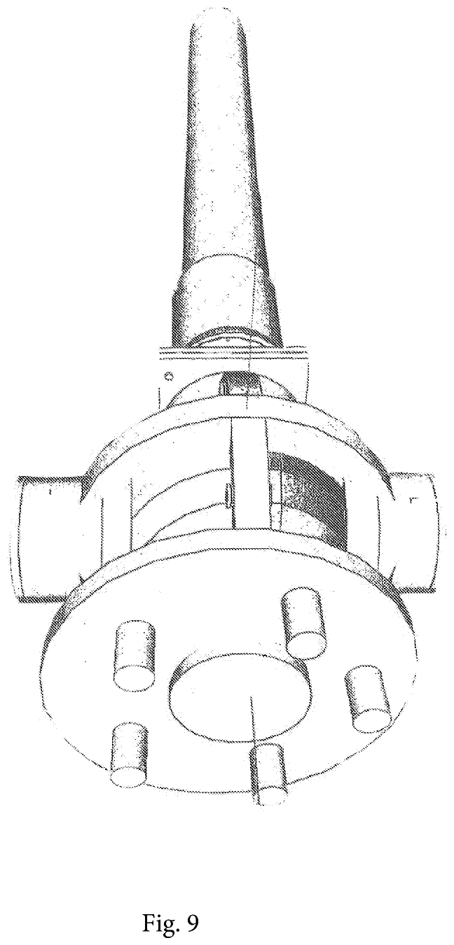

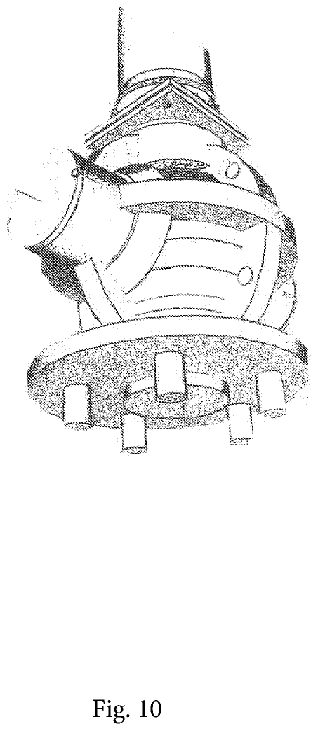

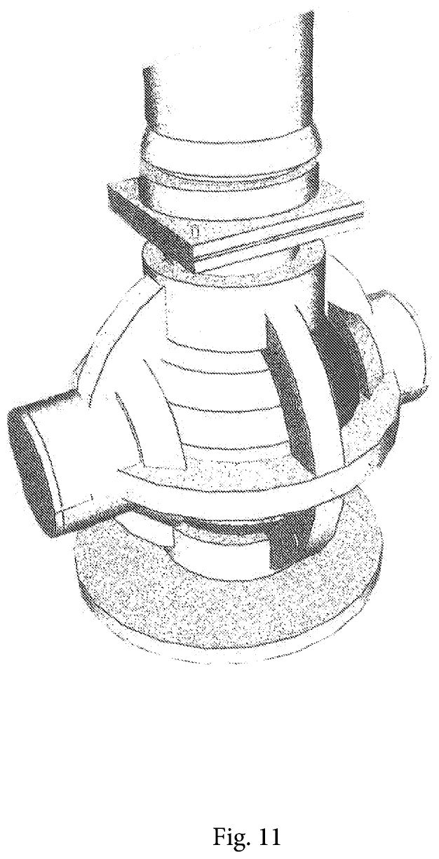

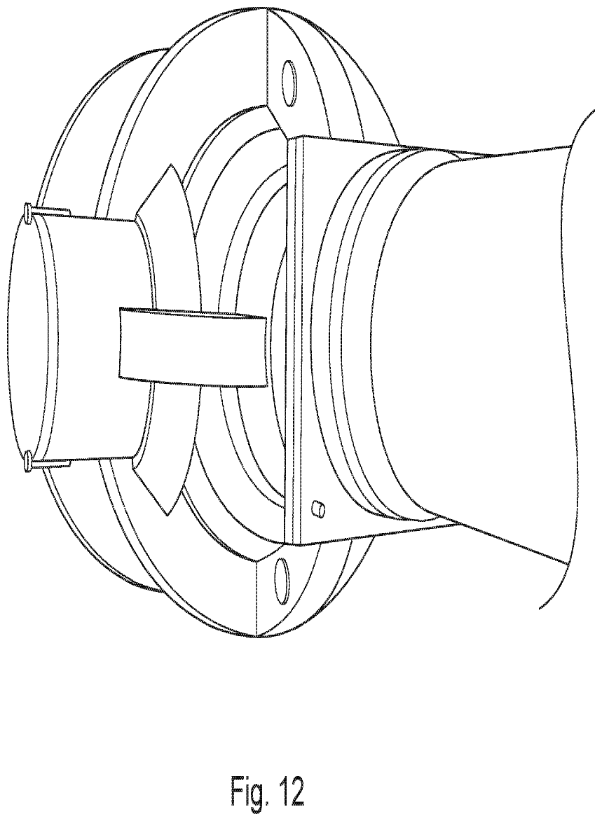

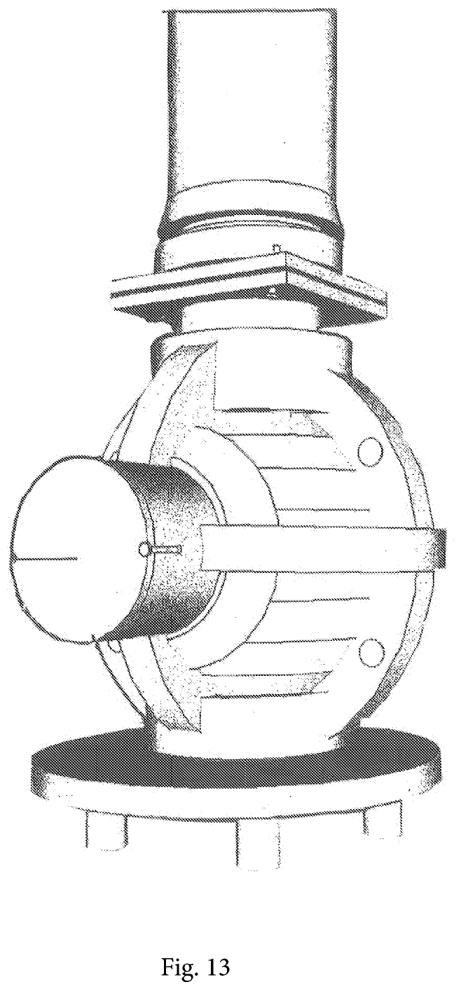

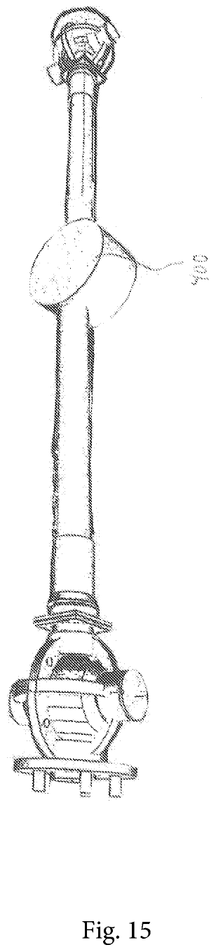

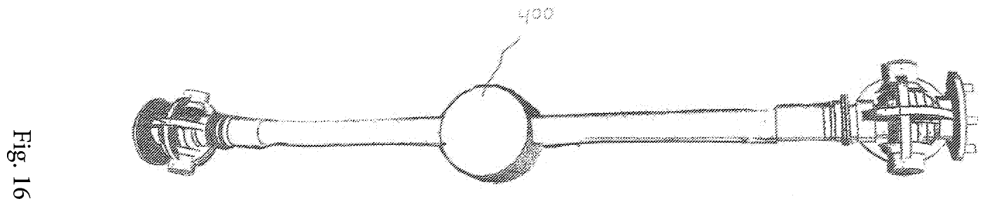

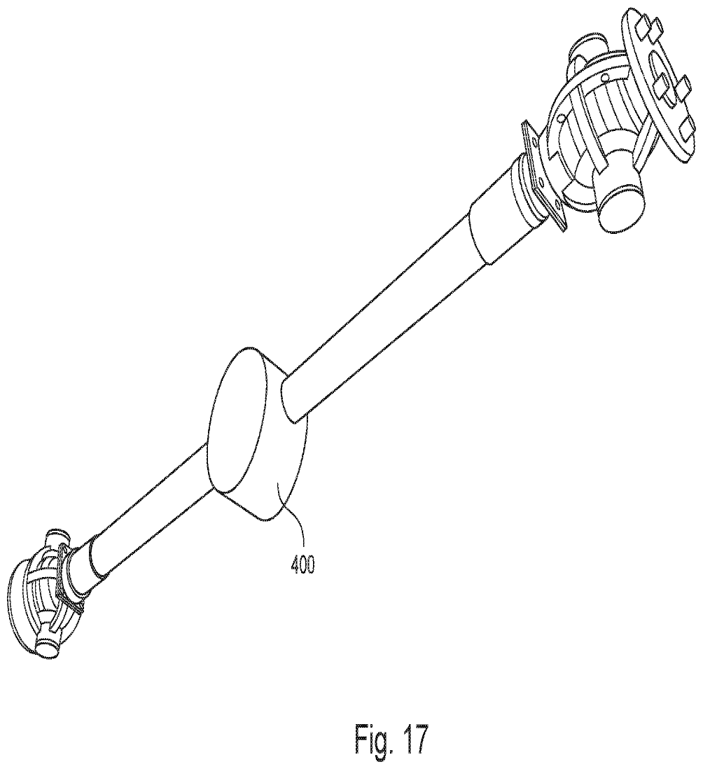

A first preferred embodiment of a brake sphere apparatus for a spherical braking system is shown in FIGS. 1-20 of the drawings. As best shown in FIGS. 4 and 15-17, a spherical braking system may have two spherical brake apparatus near respective wheels on opposite ends of an axle. There may be other mechanisms integrated with the axle, symbolically represented by system 400 in the figures, such as a differential or a driving gear. Each spherical brake apparatus is preferably integrated with the axle and connected to the wheel hub for the wheel.

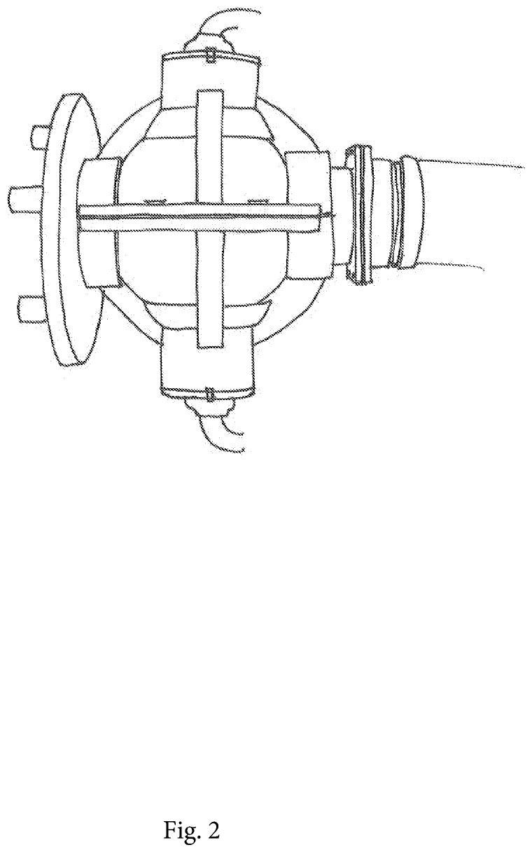

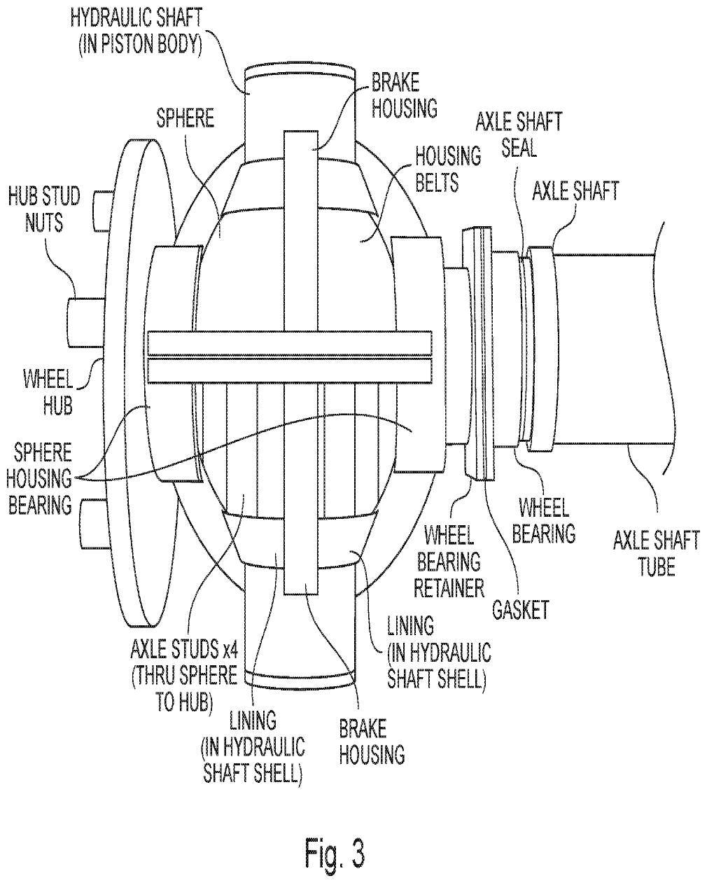

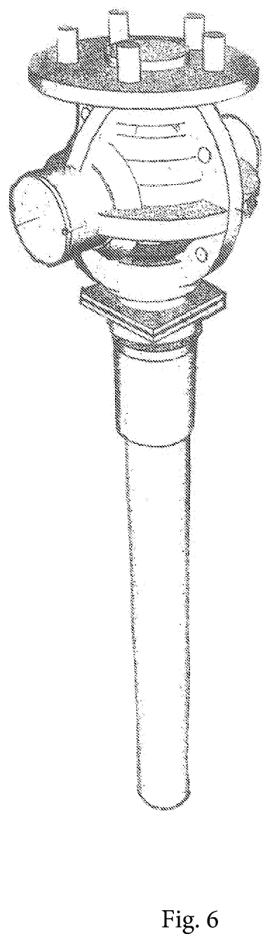

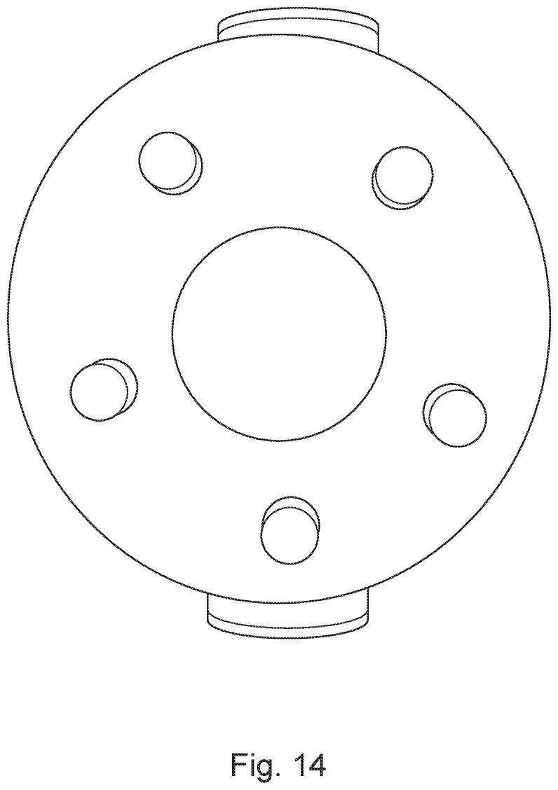

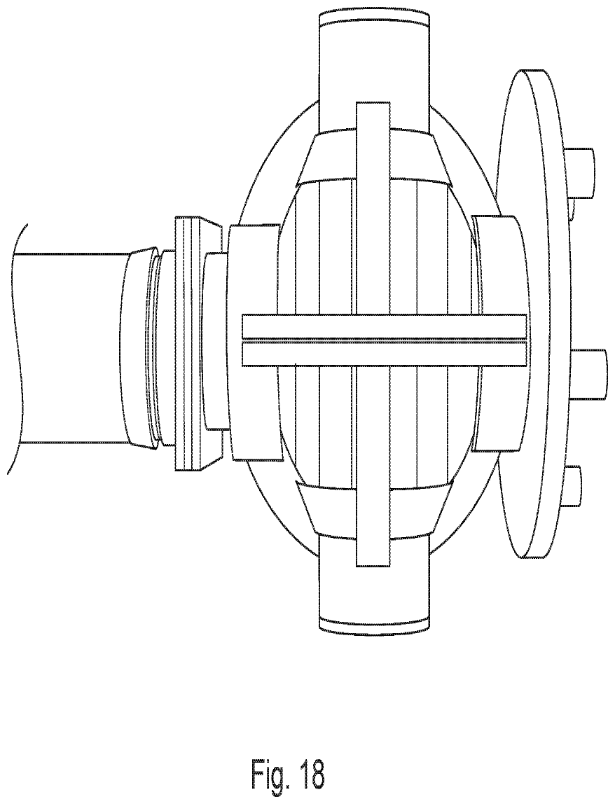

FIG. 1 depicts a side view of the brake sphere apparatus in the first preferred embodiment. The housing assembly 140 of the brake sphere apparatus contains the brake sphere 108 but is not enclosed and instead permits ample air flow around brake sphere 108 to assist in passive cooling upon braking. The housing assembly 140 may be composed of two, or four, or another number of components. There can be semi-spherical portions as suggested by FIG. 1 or a plurality of smaller ribbed components. Such components are securely connected together to form the housing such as by bolts or equivalent mechanism. FIGS. 2 and 18 show a simplified version of the spherical brake apparatus and FIG. 3 includes the labels for the elements of the spherical brake apparatus. A large number of perspective views are provided in FIGS. 6-13 to facilitate an easy grasp of the spherical shell shape of the housing 140 of the apparatus. FIG. 14 shows an end view looking at the wheel hub, and FIG. 19 shows a top view, of the spherical brake apparatus in the first preferred embodiment.

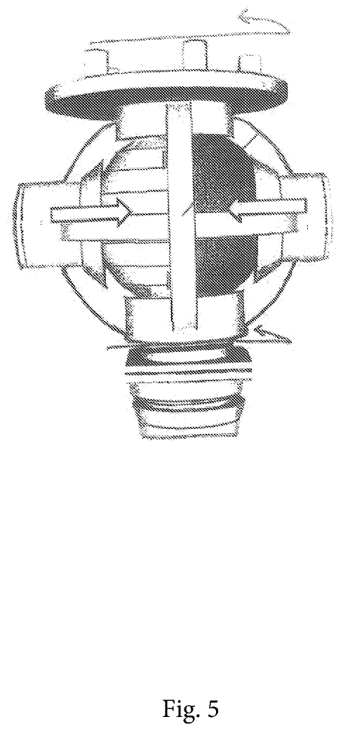

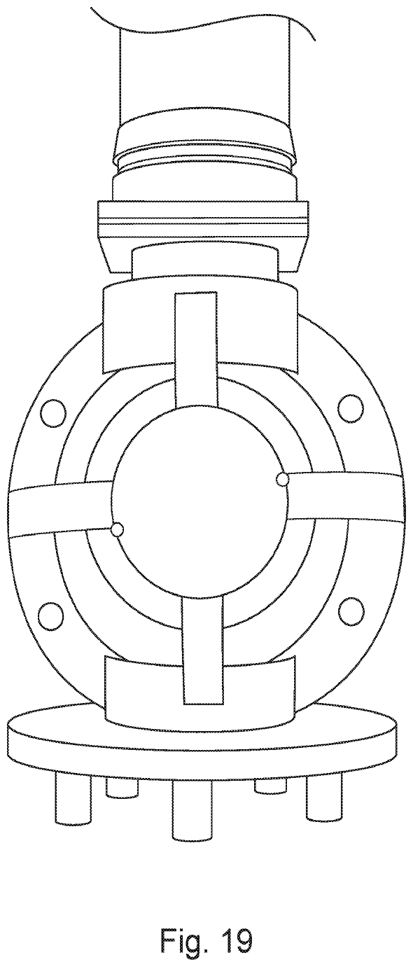

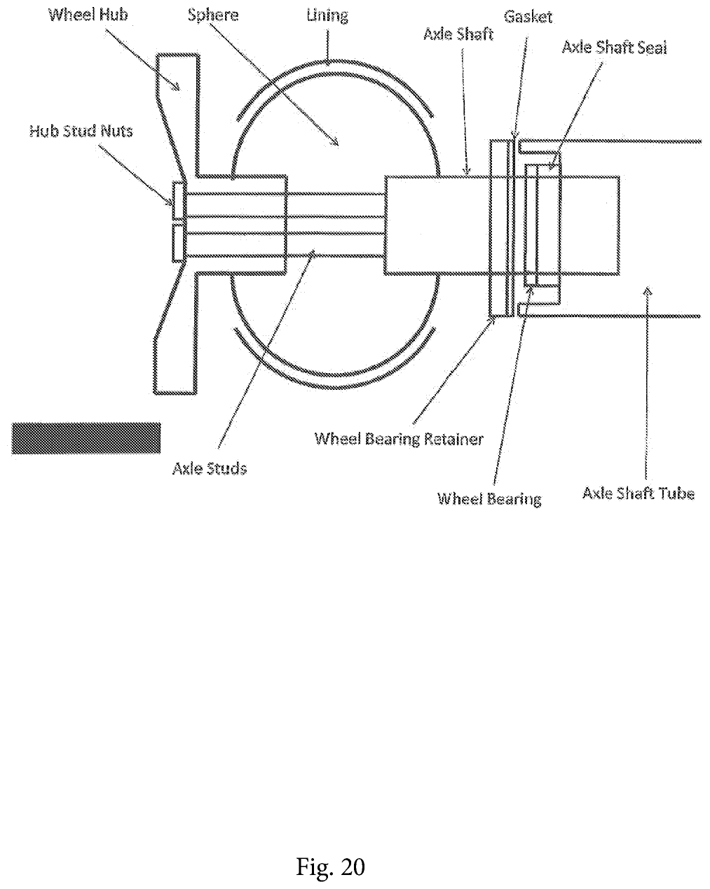

The axle shaft tube assembly 126 in the first preferred embodiment includes the axle shaft 122, wheel bearing retainer 130, wheel bearing 128, gasket 120 and axle shaft seal 124. Rotational force as shown by the dark arrows in FIG. 5 is transferred through the axle shaft 122 which is bolted to the wheel hub 102 with axle studs 136 extending through the brake sphere 108. FIG. 20 is a diagram illustrating the placement and connection of the brake sphere in between the wheel hub 102 and axle shaft 122.

Returning to FIG. 1, the brake housing assembly 140 includes the housing bolts 118, brake lining 136 on the partially spherical contact side of a brake pad, the hydraulic shaft spring 132, the hydraulic shaft 134, piston body 110, hydraulic piston body cap 116, hydraulic cap screws 114, hydraulic line 112, and sphere housing bearings 106. The hydraulic lines 112 transfer hydraulic pressure from the vehicle's factory brake system into the piston body 110. Two partially spherical brake pad linings 136 are attached to the hydraulic shafts 134, which is surrounded by a hydraulic shaft spring 132 in the piston body 110 in both opposing brake housings 140.

As force increases in the piston body 110 from the driver depressing the brake pedal, the pressure forces the hydraulic shaft 134 and partially spherical brake pad lining 136, decompressing the hydraulic shaft spring 132, against the brake sphere 108 which is attached to the axle shaft 122 and wheel hub 102 by axle studs 138 (shown by dashed lines) through the brake sphere 108. The hydraulic shaft spring biases 132 biases the brake pad lining so that it is removed from the brake sphere 108 when there is no hydraulic pressure applied. Brake torque created from the force of the partially spherical brake pad lining 136 against the brake sphere 108 slows the rotation of the axle shaft 122 and wheel hub 102, accordingly, the speed of the entire vehicle.

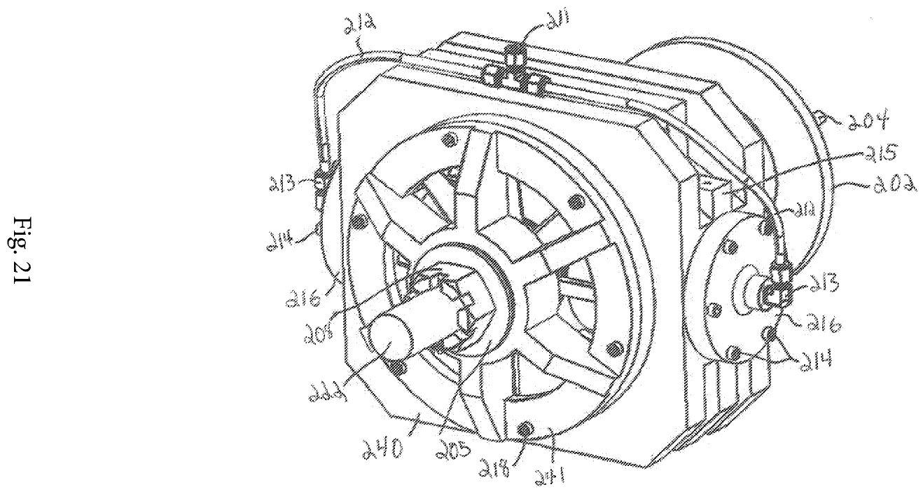

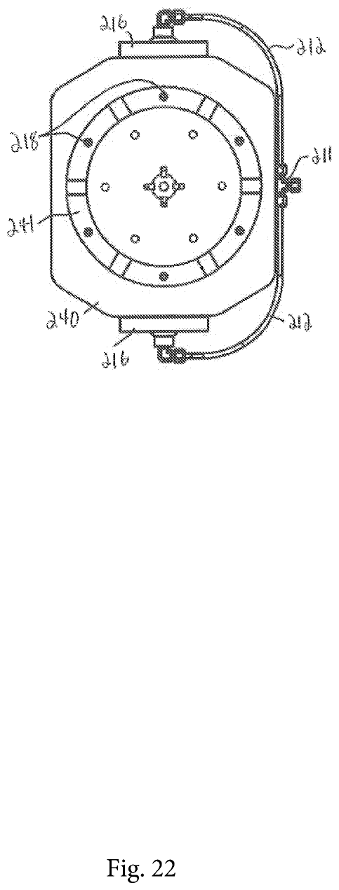

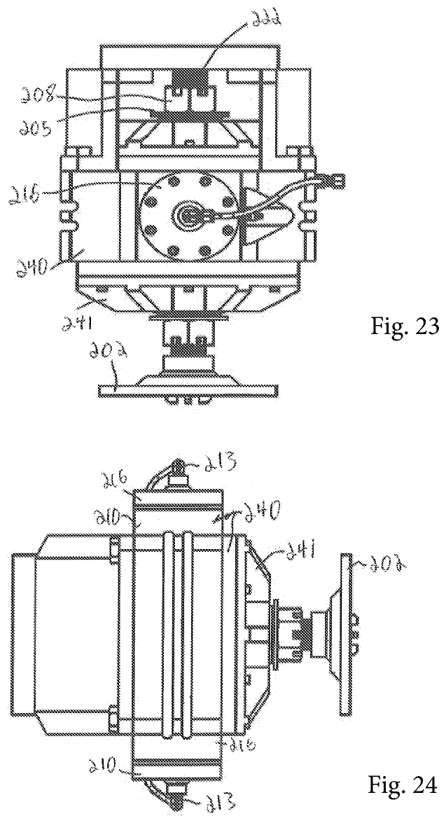

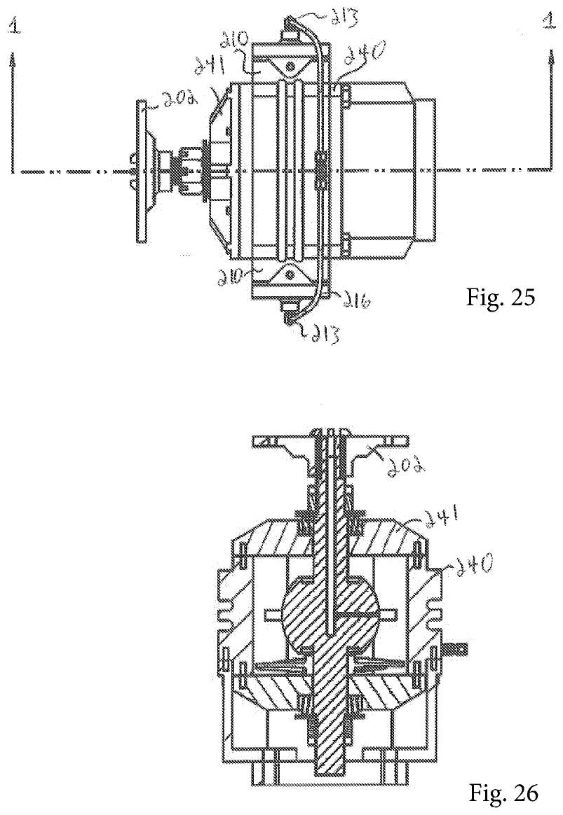

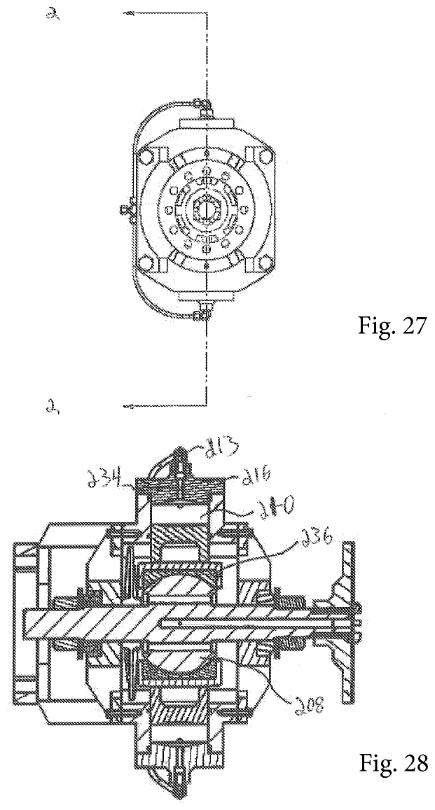

A second preferred embodiment of a brake sphere assembly for a spherical braking system is shown in FIGS. 21-29. Further perspective view drawings of the brake sphere assembly according to this embodiment are present in U.S. Provisional Patent Application No. 61/831,432 incorporated by reference into this application and those drawings are not repeatedly shown in this application.

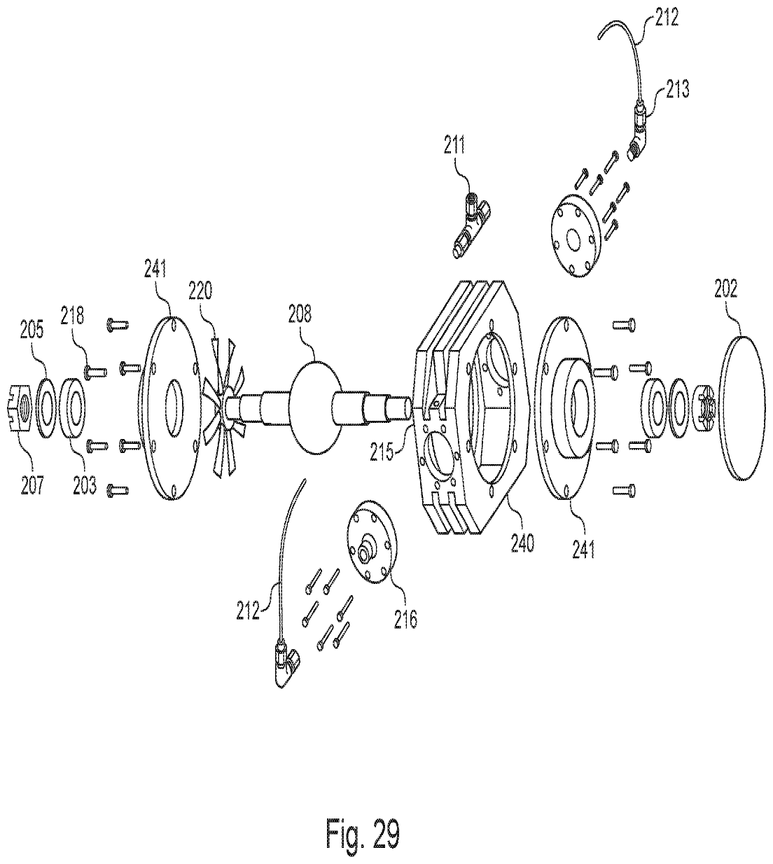

A perspective view of the second preferred embodiment is shown in FIG. 21 and an exploded assembly view is shown in FIG. 29. The second preferred embodiment significantly differs from the first preferred embodiment in that housing 240 is not of a spherical shell shape and is more of a square or rectangular outer shape with a hollowed interior having a circular cross-section. Housing 240 contains within it a brake sphere 208 integrated with axle 222 and connected to a wheel hub 202 having hub bolts 204. A bearing 203, axle washer 205, and axle nut 208 components are located at each end of axle 222. The housing 240 may be composed of a single or multiple components, and has housing end caps 241 secured on each side longitudinal with axle 222 with cap screws 218.

There are brake cylinder caps 216 connected to opposing sides of housing 240 with cylinder cap screws 214 and to hydraulic lines 212. The hydraulic shafts and pistons 215 are substantially similar to those same counterparts in the first preferred embodiment. Similarly two hydraulic lines 212 from tee fitting 211 connect to respective right angle tube fittings 213 to hydraulic shafts on the sides of the housing 240.

As shown by the cross-section views in FIGS. 26 and 28, the periphery of housing 240 in the second preferred embodiment is rather substantial as opposed to the open design of the spherical housing shell in the first preferred embodiment. Rather than passive cooling, the second preferred embodiment therefore includes a fan 220 adjacent one of the housing end caps 241 for directing air onto and cooling the brake sphere 208.

As best shown in FIG. 28, each brake pad 236 is engaged with brake sphere 208 when hydraulic pressure is applied to the hydraulic lines 212. Brake pad 236 is biased away from brake sphere 208 when not engaged by the hydraulic system. A hydraulic shaft 210 is coupled to the brake pad 236 for generating vertical movement of the brake pad 236. As brake pad 236 is pushed to engage and disengage with the brake sphere 208, spaces are created between said brake pad 236 and the sphere 208. Air driven by fan 220 facilitates cooling of friction heat generated by the engagement of said brake pad 236 with said sphere 208. The hydraulic shaft 210 is encircled by a hydraulic bushing 234, which acts as a seal preventing the leakage of fluid from braking chamber.

While the description above refers to particular embodiments of the present invention, it will be understood by those skilled in the art that many modifications may be made and equivalents may be substituted without departing from the spirit thereof. The accompanying claims are intended to cover such modifications as would fall within the true scope and spirit of the present invention. The disclosed embodiments are therefore to be considered as illustrative and not as restrictive. The scope of the invention is defined by the appended claims.

Insofar as the description above and the accompanying drawings disclose any additional subject matter that is not within the scope of the claims below, such subject matter is not dedicated to the public and the right to claim additional inventions in this or another patent application that may or may not claim the benefit of priority from this application is reserved. Particularly, it should be recognized that there may be one or more inventions which are broader in one or more respects than the inventions presented by these claims.

I claim:

1. A brake sphere apparatus comprising:
(a) a brake sphere integrated with an axle or drive shaft for a vehicle and connected to a wheel hub, said brake sphere and said wheel hub simultaneously rotating together;
(b) a housing containing the brake sphere, two brake pads on opposing sides of the brake sphere, and two hydraulic shafts respectively driving the two brake pads;
(c) two hydraulic lines connected to said two hydraulic shafts through said housing, said two hydraulic shafts pressing said two brake pads against the brake sphere when pressure is applied through said two hydraulic lines; and
(d) a cooling feature to cool said brake sphere when torque is applied to said brake sphere to decrease simultaneous rotation of said brake sphere and said wheel hub.

2. The brake sphere apparatus of claim 1 further comprising two piston bodies, said two piston bodies enclosing said hydraulic shafts.

3. The brake sphere apparatus of claim 1, wherein each one of said two brake pads has a contact side facing said brake sphere, and the contact side has a partially spherical shape.

4. The brake sphere apparatus of claim 4, wherein the contact side of each of said two brake pads has a partially spherical shape that is substantially less than a hemisphere in size.

5. The brake sphere apparatus of claim 1, wherein said cooling feature comprises a plurality of housing components connected together to form said housing in the shape of a spherical shell, there being empty spaces in the spherical shell allowing the free flow through the housing and over the surface of said brake sphere.

6. The brake sphere apparatus of claim 1, further comprising an axle stud extending through said brake sphere from said axle or drive shaft to said wheel hub.

7. The brake sphere apparatus of claim 1, further comprising housing bearings between said housing and said wheel hub and between said housing and said axle or drive shaft.
